(19) United States
(12) Patent Application Publication
(10) Pub. No.: US 2023/0019850 A1
(43) Pub. Date: Jan. 19, 2023

(54) METHOD, SYSTEM, AND NON-TRANSITORY COMPUTER-READABLE RECORDING MEDIUM FOR SUPPORTING DELIVERY USING A ROBOT

(71) Applicant: Bear Robotics, Inc., Redwood City, CA (US)

(72) Inventor: John Jungwoo Ha, Frisco, TX (US)

(73) Assignee: Bear Robotics, Inc., Redwood City, CA (US)

(21) Appl. No.: 17/376,542

(22) Filed: Jul. 15, 2021

(51) Int. Cl. G06Q 10/08; G05B 19/4155

(52) U.S. Cl. CPC G06Q 10/083; G05B 19/4155; G05B 2219/50391

(57) ABSTRACT

A method for supporting delivery using a robot is provided. The method includes the steps of: acquiring delivery information on a delivery item; determining a first location with respect to a building specified from the delivery information and causing a robot to travel to the first location; and causing the robot to travel to a second location in the building specified from the delivery information, with reference to at least one of handover information and takeover information on the delivery item.

### FIELD OF THE INVENTION

The present invention relates to a method, system, and non-transitory computer-readable recording medium for supporting delivery using a robot.

### BACKGROUND

Conventional item delivery methods have been implemented in such a way that a deliverer transports a delivery item to a delivery location and conveys it directly to a receiver, or the deliverer stores the delivery item in an unmanned delivery box near the delivery location and the receiver picks it up.

As an example of related conventional techniques, Korean Laid-Open Patent Publication No. 10-2021-0048448 discloses an unmanned door-to-door delivery system, wherein a server for an unmanned door-to-door delivery service is configured to: receive a request for storage of a delivery item from an application of a deliverer; transmit an authentication number to the application of the deliverer in response to the storage request; set a password for an unmanned delivery box in which the delivery item is stored upon successful authentication; transmit a message notifying arrival of the delivery item to a terminal of a receiver; receive a contact number of the receiver inputted to the unmanned delivery box; and transmit an authentication number to the contact number of the receiver.

However, according to the techniques introduced so far as well as the above-described conventional technique, it is often difficult for a deliverer to deliver a delivery item to a location desired by a receiver because the deliverer is restricted from entering a building (especially, a newly built building or a building requiring security), and in the case of using an unmanned delivery box, the receiver suffers from the inconvenience of having to visit a location of the delivery box to receive the delivery item.

Meanwhile, with the development of robot technology in recent years, it is possible to automate difficult tasks or repetitive operations using robots, and the robots are utilized to replace or assist people in various fields. In order to resolve the above problems that may occur in the conventional item delivery methods, a robot may be used to support so-called last mile delivery by receiving a delivery item from a deliverer and conveying the delivery item to a final delivery location.

In this connection, the inventor(s) present a novel and inventive technique for supporting last mile delivery in a building using a robot.

### SUMMARY OF THE INVENTION

One object of the present invention is to solve all the above-described problems in the prior art.

Another object of the invention is to allow a robot to receive a delivery item from a deliverer in or around a building and to convey the delivery item quickly and safely to a final delivery location in the building.

Yet another object of the invention is to allow a robot to travel to a specific location (e.g., a building entrance) in order to quickly receive a delivery item from a deliverer.

Still another object of the invention is to allow a robot to travel to a specific location (e.g., a final delivery location) in a building, with reference to at least one of handover information and takeover information on a delivery item.

The representative configurations of the invention to achieve the above objects are described below.

According to one aspect of the invention, there is provided a method for supporting delivery using a robot, the method comprising the steps of: acquiring delivery information on a delivery item; determining a first location with respect to a building specified from the delivery information and causing a robot to travel to the first location; and causing the robot to travel to a second location in the building specified from the delivery information, with reference to at least one of handover information and takeover information on the delivery item.

According to another aspect of the invention, there is provided a system for supporting delivery using a robot, the system comprising: a delivery information acquisition unit configured to acquire delivery information on a delivery item; and a travel management unit configured to determine a first location with respect to a building specified from the delivery information and cause a robot to travel to the first location, and to cause the robot to travel to a second location in the building specified from the delivery information, with reference to at least one of handover information and takeover information on the delivery item.

In addition, there are further provided other methods and systems to implement the invention, as well as non-transitory computer-readable recording media having stored thereon computer programs for executing the methods.

According to the invention, it is possible to allow a robot to receive a delivery item from a deliverer in or around a building and to convey the delivery item quickly and safely to a final delivery location in the building.

According to the invention, it is possible to allow a robot to travel to a specific location (e.g., a building entrance) in order to quickly receive a delivery item from a deliverer.

According to the invention, it is possible to allow a robot to travel to a specific location (e.g., a final delivery location) in a building, with reference to at least one of handover information and takeover information on a delivery item.

### BRIEF DESCRIPTION OF THE DRAWINGS

FIG. 1 schematically shows the configuration of an entire system for supporting delivery using a robot according to one embodiment of the invention.

FIG. 2 illustratively shows the internal configuration of a delivery support system according to one embodiment of the invention.

FIG. 3 illustratively shows a situation in which delivery is carried out in a building using a robot according to one embodiment of the invention.

FIG. 4 illustratively shows a situation in which delivery is carried out in a building using a robot according to one embodiment of the invention.

FIG. 5 illustratively shows the structure of a robot according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Configuration of the Entire System

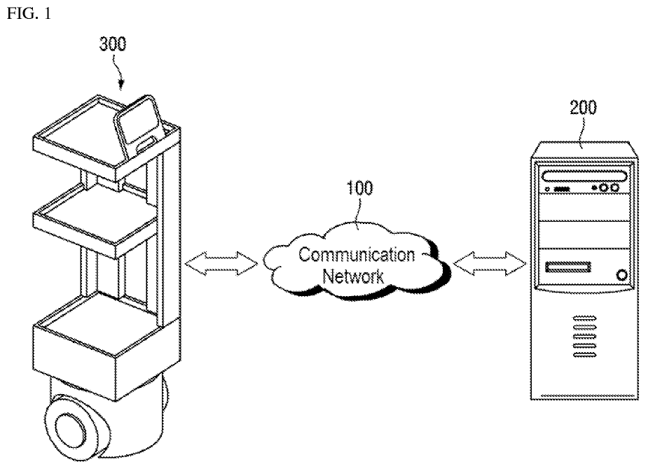

FIG. 1 schematically shows the configuration of the entire system for supporting delivery using a robot according to one embodiment of the invention.

As shown in FIG. 1, the entire system according to one embodiment of the invention may comprise a communication network 100, a delivery support system 200, and a robot 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as Wi-Fi communication, Wi-Fi Direct communication, Long Term Evolution (LTE) communication, Bluetooth communication (more specifically, Bluetooth Low Energy (BLE) communication), infrared communication, and ultrasonic communication.

Next, the delivery support system 200 according to one embodiment of the invention may communicate with the robot 300 to be described below via the communication network 100, and may function to: acquire delivery information on a delivery item; determine a first location with respect to a building specified from the delivery information and cause the robot 300 to travel to the first location; and cause the robot 300 to travel to a second location in the building specified from the delivery information, with reference to at least one of handover information and takeover information on the delivery item. Here, the building may include various types of buildings such as an apartment, an office building, a shopping arcade, and a museum.

Meanwhile, the above description is illustrative although the delivery support system 200 has been described as above, and it will be apparent to those skilled in the art that at least a part of the functions or components required for the delivery support system 200 may be implemented or included in the robot 300 to be described below or an external system (not shown), as necessary. Further, in some cases, all of the functions and components of the delivery support system 200 may be implemented or included in the robot 300.

Next, the robot 300 according to one embodiment of the invention is a device that may communicate with the delivery support system 200 via the communication network 100, and may autonomously perform predetermined functions or assigned tasks (e.g., transporting, loading, containing, or storing delivery items) without any operation of a user. The robot 300 may include at least one of a module (e.g., a grab or a robotic arm module) for loading and unloading a delivery item, a module (e.g., a container module) for containing or loading a delivery item, an image acquisition module (e.g., a visible light camera or an infrared camera) for acquiring images of surroundings, a display and speaker module for providing various images or sounds, and a drive module (e.g., a motor) for moving the robot 300. For example, the robot 300 may have characteristics or functions similar to those of at least one of a guide robot, a transport robot, a cleaning robot, a medical robot, an entertainment robot, a pet robot, and an unmanned flying robot.

Meanwhile, according to one embodiment of the invention, the robot 300 may include an application for supporting delivery according to the invention. The application may be downloaded from the delivery support system 200 or an external application distribution server (not shown).

Configuration of the Delivery Support System

Hereinafter, the internal configuration of the delivery support system 200 crucial for implementing the invention and the functions of the respective components thereof will be discussed.

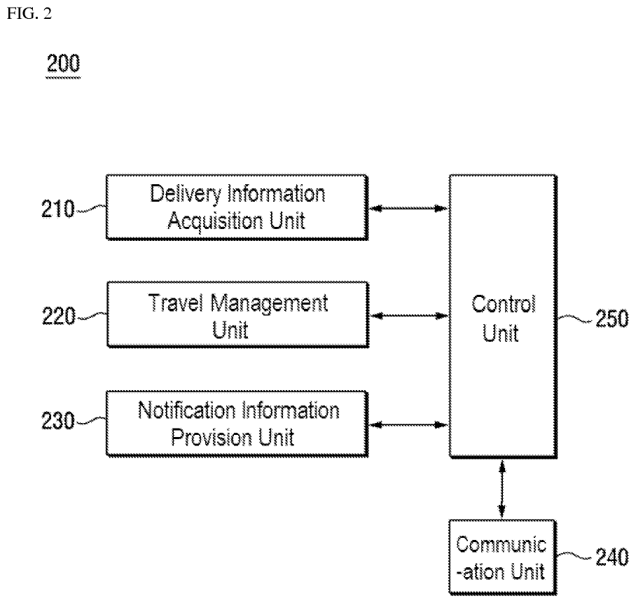

FIG. 2 illustratively shows the internal configuration of the delivery support system 200 according to one embodiment of the invention.

As shown in FIG. 2, the delivery support system 200 according to one embodiment of the invention may comprise a delivery information acquisition unit 210, a travel management unit 220, a notification information provision unit 230, a communication unit 240, and a control unit 250. According to one embodiment of the invention, at least some of the delivery information acquisition unit 210, the travel management unit 220, the notification information provision unit 230, the communication unit 240, and the control unit 250 may be program modules that communicate with an external system. The program modules may be included in the delivery support system 200 in the form of operating systems, application program modules, and other program modules, while they may be physically stored in a variety of commonly known storage devices. Further, the program modules may also be stored in a remote storage device that may communicate with the delivery support system 200. Meanwhile, such program modules may include, but are not limited to, routines, subroutines, programs, objects, components, and data structures for performing specific tasks or executing specific abstract data types according to the invention as will be described below.

First, the delivery information acquisition unit 210 according to one embodiment of the invention may function to acquire delivery information on a delivery item. The delivery item according to the invention may refer to any material object that can be moved, and may include a door-to-door delivery item, delivery food, and the like, for example. Further, the delivery information according to one embodiment of the invention may include information on properties (e.g., a type, size, quantity, damage potential, etc.) of the delivery item, information on identity (e.g., a name, trade name, address, phone number, resident registration number, etc.) of a user associated with the delivery item (e.g., a sender, a deliverer, or a receiver), and the like.

For example, the delivery information acquisition unit 210 may acquire the delivery information on the delivery item from a food delivery order platform (e.g., Coupang Eats, Baedal Minjok, or Yogiyo), a door-to-door delivery platform (e.g., CJ, DHL, or FEDEX), or an online shopping mall platform (e.g., Amazon or Coupang). More specifically, when a delivery of food is requested through a food delivery order platform, for example, the delivery information acquisition unit 210 may acquire a type of a delivery item (i.e., delivery food), a quantity of the delivery item, a name of a receiver, an address of the receiver (i.e., delivery address), a phone number of the receiver, an SNS account (e.g., KakaoTalk account) of the receiver, and the like as the delivery information on the delivery item.

Next, the travel management unit 220 according to one embodiment of the invention may function to determine a first location with respect to a building specified from the delivery information acquired by the delivery information acquisition unit 210 and cause the robot 300 to travel to the first location.

For example, the travel management unit 220 may determine the first location with respect to the building specified from the delivery information, with reference to a location of a deliverer who conveys the delivery item to the robot 300 (e.g., a location of a device carried or used by the deliverer). More specifically, the travel management unit 220 may determine an entrance located within a predetermined distance from (or closest to) the location of the deliverer, among a plurality of entrances of the building containing a delivery location, as the first location.

As another example, the travel management unit 220 may determine the first location with reference to a delivery location in the building to which the delivery item is to be conveyed. More specifically, the travel management unit 220 may determine an entrance located within a predetermined distance from (or closest to) a delivery location in the building specified from the delivery information (e.g., the receiver's location in the building), among a plurality of entrances of the building, as the first location.

Meanwhile, although the embodiments in which the first location according to one embodiment of the invention is an entrance of a building have been mainly described above, the first location is not necessarily limited to the entrance of the building. It is noted that the first location according to the invention may include a location adjacent to the building where it is easy to contact a deliverer, as long as the objects of the invention may be achieved.

Further, the travel management unit 220 may cause the robot 300 to travel to the first location with reference to estimated time required for the deliverer to arrive at the building specified from the delivery information or the first location of the building.

For example, the travel management unit 220 may estimate the required time with reference to a distance between the location of the deliverer and the building specified from the delivery information (or the first location of the building), and may cause the robot 300 to travel to the first location according to the estimated required time (or prior to the deliverer's arrival). More specifically, the estimated required time according to one embodiment of the invention may be determined with reference to information on a pattern of the required time according to day of week, hours, the location of the building, the first location, the location of the deliverer, and the like (e.g., information on a pattern of the time required for the deliverer to arrive at the building on the day of the week), or may be determined on the basis of a result of learning the information on the pattern of the required time.

In addition, the travel management unit 220 may determine a robot 300 to travel to the first location with reference to task information of a plurality of robots 300 in the building. The task information according to one embodiment of the invention may include information on a type (e.g., travel to a first location, travel to a second location, etc.), estimated start time, estimated end time, importance, and the like of a task.

For example, the travel management unit 220 may estimate an end time of a task being performed by each robot 300, with reference to information on tasks assigned to the plurality of robots 300 in the building, and may determine a robot 300 whose task end time precedes the time of the deliverer's arrival at the building specified from the delivery information (or the first location of the building), or whose task end time is similar to the time of the deliverer's arrival at the building (or the first location of the building) at or above a predetermined level, as the robot 300 to travel to the first location.

Further, the travel management unit 220 may determine a robot 300 to travel to the first location with reference to information on properties of the delivery item. The information on the properties of the delivery item according to one embodiment of the invention may include information on a type, size, quantity, damage potential (e.g., whether the delivery item is a fragile item such as glass), and the like of the delivery item.

For example, the travel management unit 220 may determine a robot 300 having a containing space or loading space capable of accommodating the delivery item, among a plurality of robots 300, as the robot 300 to travel to the first location with reference to a size and quantity of the delivery item.

Further, the travel management unit 220 according to one embodiment of the invention may cause the robot 300 to travel to a second location specified from the delivery information, with reference to at least one of handover information and takeover information on the delivery item. According to one embodiment of the invention, the handover information may be information indicating that the deliverer has normally handed over the delivery item to the robot 300, and the takeover information may be information indicating that the robot 300 has normally taken over the delivery item.

For example, when the deliverer provides delivery completion information indicating that the deliverer has conveyed the delivery item to the robot 300, information indicating that the delivery item has been normally handed over to the robot 300 may be determined as the handover information on the delivery item, on the basis of the delivery completion information. The travel management unit 220 may cause the robot 300 to travel to a final delivery location (e.g., the receiver's address) in the building, with reference to the handover information on the delivery item.

As another example, when the delivery item is loaded into the robot 300 and information on the loaded delivery item (which may be acquired by recognizing a type, quantity, shape, and the like of the loaded delivery item using an image sensor, a weight sensor, and the like, or acquired on the basis of identification information such as a QR code marked on the loaded delivery item, for example) matches with information on the delivery item specified from the delivery information, information indicating that the robot 300 has normally taken over the delivery item may be determined as the takeover information on the delivery item. The travel management unit 220 may cause the robot 300 to travel to a final delivery location (e.g., the receiver's address) in the building, with reference to the takeover information on the delivery item.

Next, the notification information provision unit 230 according to one embodiment of the invention may function to provide information on the first location to the deliverer when the first location is determined by the travel management unit 220.

For example, when the first location is determined with respect to the building specified from the delivery information, the notification information provision unit 230 may provide geographic information (e.g., Google Map or a link thereof) on the first location to the deliverer.

Further, the notification information provision unit 230 may provide notification information to a user associated with the delivery item (e.g., the sender, deliverer, or receiver) with reference to a location of the robot 300 in the building. For example, the notification information may be information on a type, travel route, arrival status, and the like of the delivery item. Further, the notification information may be provided to a device (e.g., a digital device such as a smart phone) carried or used by the user (e.g., via a text message, phone call, SNS, etc.) or may be provided via a display, speaker, and the like of the robot 300.

For example, when the robot 300 arrives at the second location (e.g., the receiver's address) in the building, the notification information provision unit 230 may provide the notification information to the receiver who is to receive the delivery item.

Meanwhile, the notification information provision unit 230 may allow the delivery item to be provided through authentication of the receiver who is to receive the delivery item.

For example, the notification information provision unit 230 may carry out authentication with reference to identification information (e.g., fingerprint information, face recognition information, information on a resident registration number or passport number, information on a preset password, etc.) of the receiver who is to receive the delivery item (e.g., may check whether the identification information of the receiver matches with information on the receiver specified from the delivery information), and when the authentication is normally carried out, may unlock the loading space or containing space of the robot 300 so that the receiver may take out the delivery item therefrom, or cause the robot 300 to take out the delivery item and convey it to the receiver.

Next, according to one embodiment of the invention, the communication unit 240 may function to enable data transmission/reception from/to the delivery information acquisition unit 210, the travel management unit 220, and the notification information provision unit 230.

Lastly, according to one embodiment of the invention, the control unit 250 may function to control data flow among the delivery information acquisition unit 210, the travel management unit 220, the notification information provision unit 230, and the communication unit 240. That is, the control unit 250 according to one embodiment of the invention may control data flow into/out of the delivery support system 200 or data flow among the respective components of the delivery information acquisition unit 210, the travel management unit 220, the notification information provision unit 230, and the communication unit 240 may carry out their particular functions, respectively.

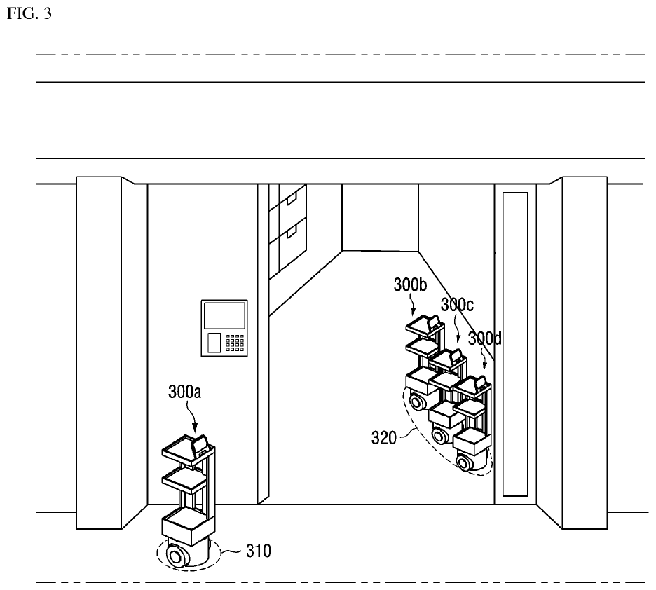

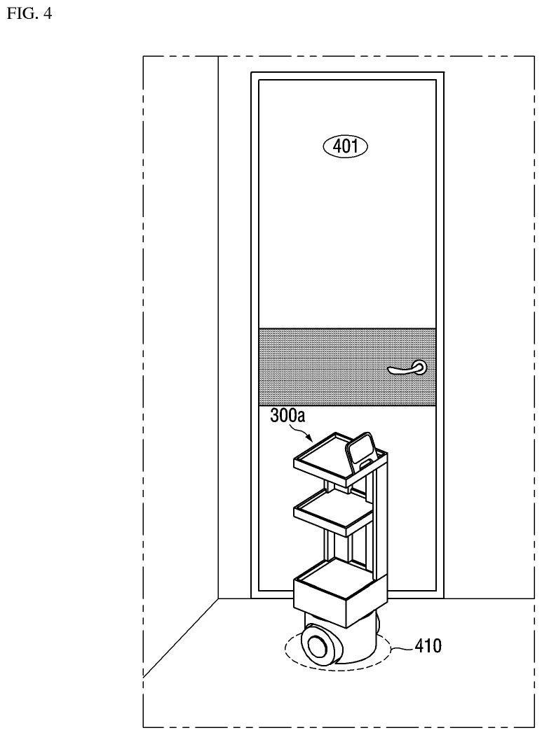

FIGS. 3 and 4 illustratively show a situation in which delivery is carried out in a building using a robot according to one embodiment of the invention.

Referring to FIG. 3, it may be assumed that a building according to the invention is an apartment, and delivery is supported using a plurality of robots 300a, 300b, 300c, and 300d in the apartment.

First, according to one embodiment of the invention, an order for food B may be made on a certain food delivery order platform by user A who resides in building 101, unit 401 of the apartment.

Next, according to one embodiment of the invention, the delivery support system 200 may acquire delivery information on a delivery item (i.e., the food B) from the food delivery order platform. The delivery information may include a type of the food B, a quantity of the food B, a name of the user A, a phone number of the user A, an address of the user A, and the like.

Next, according to one embodiment of the invention, a first location 310 may be determined with respect to the apartment specified from the delivery information on the delivery item. For example, an entrance located within a predetermined distance from (or closest to) the user A's address (i.e., building 101, unit 401), among a plurality of entrances of the apartment, may be determined as the first location 310.

Further, according to one embodiment of the invention, the first robot 300a may be determined as the robot 300a to travel to the first location 310, with reference to information on tasks assigned to the plurality of robots 300a, 300b, 300c, and 300d in the building. For example, the second robot 300b, the third robot 300c, and the fourth robot 300d may have already been assigned tasks of traveling to other locations.

Next, according to one embodiment of the invention, the first robot 300a may travel to the first location 310 from a location 320 where the plurality of robots 300a, 300b, 300c, and 300d in the building are located (or are on standby).

Next, according to one embodiment of the invention, when handover information indicating that the delivery item has been normally handed over is provided by a deliverer who conveys the delivery item to the first robot 300a putting the delivery item into a containing space (or loading space) of the first robot 300a and providing delivery completion information, or when takeover information indicating that the delivery item has been normally taken over is provided with reference to information on the delivery item loaded into the first robot 300a, the first robot 300a may travel to a second location specified from the delivery information (i.e., the user A's address, building 101, unit 401).

Next, referring to FIG. 4, when the first robot 300a arrives at a second location 410 according to one embodiment of the invention, notification information indicating that the delivery item has arrived may be provided to a receiver who is to receive the delivery item (i.e., the user A).

Next, according to one embodiment of the invention, when authentication (e.g., face authentication, password authentication, etc.) of the user A is normally carried out, the delivery item may be provided from the first robot 300a to the user A.

Although the embodiments in which the robot 300 carries out delivery in one building have been mainly described above, the present invention is not necessarily applied only to the cases in which the robot 300 carries out delivery in one building, and the robot 300 may also carry out delivery according to the invention in a plurality of buildings (e.g., if the building according to the invention is a hotel, a visitor center building of the hotel may contain the first location and an accommodation building of the hotel may contain the second location). Further, although the embodiments in which a delivery item is conveyed to a delivery location by one robot 300 have been mainly described above, the present invention is not necessarily applied only to the cases in which a delivery item is conveyed by one robot 300, and a plurality of robots 300 may interwork to convey a delivery item to a delivery location in a relay manner (e.g., the first robot 300a may convey a delivery item to the second robot 300b, and the second robot 300b may convey the delivery item to the user A's address).

Configuration of the Robot

The robot 300 according to one embodiment of the invention may be a robot performing tasks similar to those performed by at least one of a guide robot, a serving robot, a transport robot, a cleaning robot, a medical robot, an entertainment robot, a pet robot, and an unmanned flying robot, and may be implemented in various forms corresponding to the respective tasks.

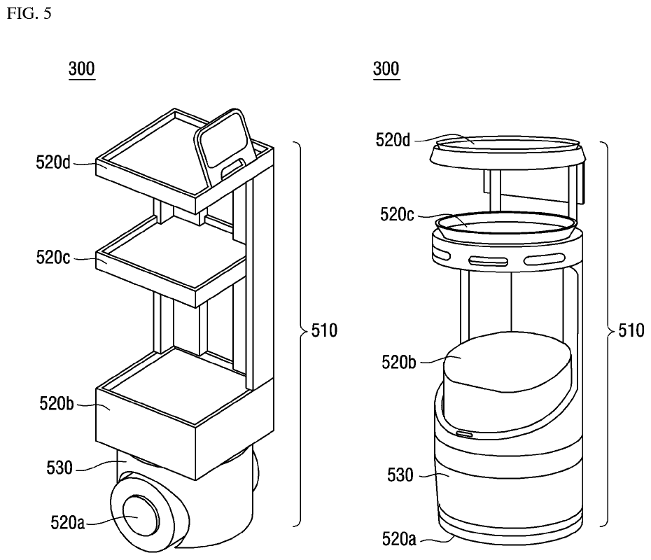

FIG. 5 illustratively shows the structure of a robot according to one embodiment of the invention.

Referring to FIG. 5, the robot 300 may comprise a main body 510, a drive unit 520a, 520b, 520c, 520d, and a processor 530.

For example, the main body 510 according to one embodiment of the invention may include at least one loading space for loading (or at least one containing space for containing) a delivery item. The loading space or containing space may be provided with a locking device (e.g., a password-based locking device).

For example, the robot 300 may include a first space 520b and a second space 520c for transporting, loading, containing, or storing the delivery item. Further, the robot 300 may further include a third space 520d that is an expansion space provided via a removable pillar, and more loading spaces (or containing spaces) may be provided by adding more expansion spaces as needed. However, the loading spaces (or containing spaces) of the robot 300 according to the invention are not necessarily limited to the above description, and may be diversely implemented as other types of loading spaces or containing spaces as long as the objects of the invention may be achieved.

In addition, the main body 510 may further include an image acquisition module (e.g., a visible light camera or an infrared camera) (not shown) and a scanner module (e.g., a LIDAR sensor) for acquiring images of surroundings (e.g., other people or things around the robot 300, other robots 300, etc.) and information on obstacles.

Next, the drive unit 520a, 520b, 520c, 520d according to one embodiment of the invention may comprise a module for moving the main body 510 to other locations, a module for loading and unloading the delivery item, or a module for opening and closing the loading space (or containing space).

For example, the drive unit 520a, 520b, 520c, 520d may include: a module related to electrically, mechanically, or hydraulically driven wheels, propellers, or the like as the module for moving the main body 510 to other locations; a robotic arm module for mounting and conveying the delivery item as the module for loading and unloading the delivery item; and an electronic or mechanical shutter device or locking device as the module for opening and closing the loading space (or containing space).

Next, the processor 530 according to one embodiment of the invention may be electrically connected to the drive unit 520a, 520b, 520c, 520d to perform a function of controlling the drive unit 520a, 520b, 520c, 520d (and may include a communication module for communicating with an external system). For example, the processor 530 may refer to a data processing device that are embedded in hardware and have circuits physically structured to perform codes included in a program or functions represented by instructions. For example, such a data processing device embedded in hardware may include a processing device such as a microprocessor, a central processing unit, a processor core, a multiprocessor, an application-specific integrated circuit (ASIC), and a field programmable gate array (FPGA).

Further, the processor 530 may perform the functions of at least one of the delivery information acquisition unit 210, the travel management unit 220, and the notification information provision unit 230 of the delivery support system 200 according to the invention (e.g., the corresponding functions may be modularized and included in the processor 530), and may function to control the drive unit 520a, 520b, 520c, 520d through communication with an external system (not shown) that performs the functions of at least one of the delivery information acquisition unit 210, the travel management unit 220, and the notification information provision unit 230.

Specifically, the processor 530 may function to: acquire delivery information on a delivery item; determine a first location with respect to a building specified from the delivery information and cause the robot 300 to travel to the first location; and cause the robot 300 to travel to a second location in the building specified from the delivery information, with reference to at least one of handover information and takeover information on the delivery item.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for supporting delivery using a robot, the method comprising the steps of:
acquiring delivery information on a delivery item;
determining a first location with respect to a building specified from the delivery information and causing a robot to travel to the first location; and
causing the robot to travel to a second location in the building specified from the delivery information, with reference to at least one of handover information and takeover information on the delivery item.

2. The method of claim 1, wherein in the step of causing the robot to travel to the first location, the first location is determined with reference to a location of a deliverer who conveys the delivery item to the robot.

3. The method of claim 1, wherein in the step of causing the robot to travel to the first location, the first location is determined with reference to a location in the building to which the delivery item is to be conveyed.

4. The method of claim 1, wherein in the step of causing the robot to travel to the first location, the robot is caused to travel to the first location with reference to estimated time required for a deliverer who conveys the delivery item to the robot to arrive at the building or the first location.

5. The method of claim 1, further comprising the step of:
providing information on the first location to a deliverer who conveys the delivery item to the robot when the first location is determined.

6. The method of claim 1, wherein in the step of causing the robot to travel to the first location, a robot to travel to the first location is determined with reference to task information of a plurality of robots in the building.

7. The method of claim 1, wherein in the step of causing the robot to travel to the first location, a robot to travel to the first location is determined with reference to information on properties of the delivery item.

8. The method of claim 1, wherein in the step of causing the robot to travel to the second location, the handover information on the delivery item is determined with reference to delivery completion information provided by a deliverer who conveys the delivery item to the robot.

9. The method of claim 1, wherein in the step of causing the robot to travel to the second location, when the delivery item is loaded into the robot, the takeover information on the delivery item is determined with reference to information on the loaded delivery item.

10. The method of claim 1, further comprising the step of:
providing notification information to a user associated with the delivery item with reference to a location of the robot in the building.

11. The method of claim 10, wherein the notification information is provided to a receiver who is to receive the delivery item when the robot arrives at the second location.

12. The method of claim 10, wherein the delivery item is allowed to be provided to a receiver who is to receive the delivery item through authentication of the receiver.

13. A non-transitory computer-readable recording medium having stored thereon a computer program for executing the method of claim 1.

14. A system for supporting delivery using a robot, the system comprising:
a delivery information acquisition unit configured to acquire delivery information on a delivery item; and
a travel management unit configured to determine a first location with respect to a building specified from the delivery information and cause a robot to travel to the first location, and to cause the robot to travel to a second location in the building specified from the delivery information, with reference to at least one of handover information and takeover information on the delivery item.

15. The system of claim 14, wherein the travel management unit is configured to determine the first location with reference to a location of a deliverer who conveys the delivery item to the robot.

16. The system of claim 14, wherein the travel management unit is configured to determine the first location with reference to a location in the building to which the delivery item is to be conveyed.

17. The system of claim 14, wherein the travel management unit is configured to cause the robot to travel to the first location with reference to estimated time required for a deliverer who conveys the delivery item to the robot to arrive at the building or the first location.

18. The system of claim 14, further comprising:
a notification information provision unit configured to provide information on the first location to a deliverer who conveys the delivery item to the robot when the first location is determined.

19. The system of claim 14, wherein the travel management unit is configured to determine a robot to travel to the first location with reference to task information of a plurality of robots in the building.

20. The system of claim 14, wherein the travel management unit is configured to determine a robot to travel to the first location with reference to information on properties of the delivery item.

21. The system of claim 14, wherein the travel management unit is configured to determine the handover information on the delivery item with reference to delivery completion information provided by a deliverer who conveys the delivery item to the robot.

22. The system of claim 14, wherein the travel management unit is configured to, when the delivery item is loaded into the robot, determine the takeover information on the delivery item with reference to information on the loaded delivery item.

23. The system of claim 14, further comprising:
a notification information provision unit configured to provide notification information to a user associated with the delivery item with reference to a location of the robot in the building.

24. The system of claim 23, wherein the notification information provision unit is configured to provide the notification information to a receiver who is to receive the delivery item when the robot arrives at the second location.

25. The system of claim 23, wherein the notification information provision unit is configured to allow the delivery item to be provided to a receiver who is to receive the delivery item through authentication of the receiver.
